(19) United States
(12) Patent Application Publication
(10) Pub. No.: US 2020/0111084 A1
(43) Pub. Date: Apr. 9, 2020

(54) MULTI-PARTY PAYMENT CARD PROCESSING SYSTEMS AND METHODS INCLUDING VIRTUAL PREPAID FOREIGN CURRENCY ACCOUNT MANAGEMENT

(71) Applicant: MASTERCARD INTERNATIONAL INCORPORATED, Purchase, NY (US)

(72) Inventors: Robert Ward, Harpenden (GB); Simon Wright Lakin, Lincs (GB); Amy Mizon, Stamford (GB)

(21) Appl. No.: 16/151,152

(22) Filed: Oct. 3, 2018

(51) Int. Cl. G06Q 20/38; G06Q 20/40; G06Q 20/10; G06Q 20/22; G06Q 20/28

(52) U.S. Cl. CPC G06Q 20/381; G06Q 20/4097; G06Q 20/405; G06Q 20/023; G06Q 20/227; G06Q 20/28; G06Q 20/108

(57) ABSTRACT

A payment card processing system and method includes a computing device in communication with a multi-party payment processing system and network for processing payment card transactions. The computing device accepts a foreign currency deposit into a virtual foreign currency account linked to a cardholder account designated for payment in a home currency, receives payment card transaction data, identifies a foreign exchange transaction between the cardholder and a merchant designated for payment in a foreign currency, and applies at least a portion of the foreign currency deposit in the virtual foreign currency account to satisfy the payment for the transaction.

### BACKGROUND

This disclosure relates generally to electronic payment systems for payment card transactions, and more specifically to electronic payment card systems and methods including foreign exchange transaction authorization with virtual prepaid foreign currency accounts linked to payment card accounts for home currency transactions.

Electronic payment card processing systems are in widespread use to process transactions between a payment cardholder and an issuing bank on the one hand, and a merchant and an acquiring bank on the other. The transaction may involve the physical payment card itself at a point-of-sale (POS) terminal, a device associated with a payment card (or an account of a payment card) that includes payment card information and digital payment capability (e.g., a smart phone device including a digital wallet or a dongle), or manually entered payment card information via another device such as a computer device interfacing with a merchant online. Sophisticated multi-party payment card processing systems are known to process payment card transactions, confirm authorized charges, manage payments and the transfers of funds, confirm payment status, and compute available credit balances.

When a cardholder uses a payment card (e.g., a credit card or a debit card) to initiate a transaction to purchase goods or services from a merchant, an acquiring bank (i.e., the merchant's bank) will typically reimburse the merchant for the transaction, less a service fee. The acquiring bank will “settle” the transaction with the issuing bank (i.e., the bank that issued the payment card account used in the transaction) by presenting transaction data to the issuing bank, either directly or, more often, via a payment processor. In a process known as clearing, transaction data is communicated from the acquiring bank to the issuing bank. After clearing, settlement of the final payment occurs. Settlement is a process used to exchange funds between the acquiring bank and the issuing bank for the net value of a batch of all monetary transactions that have cleared for that processing day.

As conventionally implemented, when a payment card issued to a cardholder in a first country having a first currency is used to conduct a transaction with a merchant in a different country using a second currency different from the first, a currency conversion is required by the payment card processing system to clear and settle the transaction. Since currency conversion rates fluctuate over time, the conversion rate at the time of the purchase may be different from the conversion rate at the time the transaction clears and settles on the payment system, and accordingly the transaction may be finally settled in an amount that does not match the contemplated purchase amount when the transaction was made. This can be problematic to cardholders, issuing banks and acquiring banks in certain aspects. Improvements are desired.

### BRIEF DESCRIPTION

In one aspect, the disclosure provides an electronic payment card processing system including at least one host computing device comprising at least one processor in communication with a memory device and a multi-party payment processing system and network for processing payment card transactions. The at least one host computing device is configured to, receive transaction data for a plurality of payment card transactions, and identify, based on the received transaction data, at least one foreign exchange transaction including a payment card account designated for payment in a home currency and a merchant designated for payment in a foreign currency. For each payment card account in an identified foreign exchange transaction, the at least one host computing device is configured to: identify whether at least one virtual prepaid foreign currency account that is linked to the payment card account is available; and if the at least one available virtual prepaid foreign currency account is available, apply at least a portion of the funds from the at least one virtual prepaid foreign currency account to satisfy the payment for the foreign exchange transaction.

In another aspect, the disclosure provides a method for electronically responding to disputed charges for payment card transactions processed by a multi-party payment processing system. The method is implemented with at least one host computing device having at least one processor in communication with a memory device and the multi-party payment processing system. The method includes receiving transaction data for a plurality of payment card transactions, and identifying, by the at least one host computing device and based on the received transaction data, at least one foreign exchange transaction including a payment card account designated for payment in a home currency and a merchant designated for payment in a foreign currency. The method also includes, for each payment card account in an identified foreign exchange transaction, identifying by the at least one host computing device whether at least one virtual prepaid foreign currency account that is linked to the payment card account is available. If the at least one available virtual prepaid foreign currency account is available, the method includes applying at least a portion of the funds from the at least one virtual prepaid foreign currency account to satisfy the payment for the foreign exchange transaction.

### BRIEF DESCRIPTION OF THE DRAWINGS

FIG. 1 is a schematic diagram illustrating an exemplary multi-party payment network system for processing payment card transactions.

FIG. 2 is a schematic diagram illustrating an exemplary online foreign currency account manager system that is operative with the payment processing network system shown in FIG. 1 in one embodiment.

FIG. 3 illustrates an operational schematic diagram for the foreign currency account manager system shown in FIG. 2.

FIG. 4 illustrates an example configuration of a user device for the system shown in FIGS. 1-3.

FIG. 5 is a schematic diagram of an example server computing device that may be used with the computer system shown in FIG. 3.

FIG. 6 shows an example configuration of a user account database within a computing device, along with other related computing components, that may be used to create, organize, and monitor a plurality of user data associated with a user.

FIG. 7 shows an exemplary process of foreign currency account management for the system shown in FIGS. 1-4.

### DETAILED DESCRIPTION OF THE DISCLOSURE

The following detailed description illustrates embodiments of the disclosure by way of example and not by way of limitation. The description enables one skilled in the art to make and use the disclosure, describes several embodiments, adaptations, variations, alternatives, and uses of the disclosure, including what is presently believed to be the best mode of carrying out the disclosure.

In conventional payment card processing systems, certain problems and challenges presented by payment card transactions between cardholders and merchants using different currencies. Such problems are described in detail below, followed be exemplary embodiments of systems and methods addressing such problems.

Payment cards are typically designated by an issuer for payment in a single currency (e.g., US dollars, Euros, or British pound sterling). For purposes of the present disclosure, the designated currency for a payment card account is referred to as a home currency. In general, payment card issuers create cardholder accounts facilitating payment in a home currency corresponding to the residence of the cardholder. As such, and for example, a cardholder residing in the United States will be issued a payment card account designated for payment in US dollars, and a cardholder in England will be issued a payment card account designated for payment in British pound sterling. Payment card transactions between cardholders and merchants using the same home currency are straightforward, familiar, and transparent in that the cardholder is charged the exact purchase amount in each payment card transaction.

Payment card transactions conducted between cardholders and merchants using different currencies, referred to herein as foreign exchange transactions, are sometimes not as straightforward, familiar or transparent from the cardholder's perspective. Cardholder purchases from a merchant designated for payment in a currency different from the home currency, referred to herein as a foreign currency, requires a currency conversion to complete the transaction. Floating currency conversion rates means that a foreign exchange transaction can settle in an amount different from the purchase price since settlement typically occurs days later and are therefore subject to a different currency conversion rate. Over a number of transactions at different times, different currency conversion rates may apply to each of the transactions.

For example, consider a US resident cardholder making a transaction using a payment card designated for payment in the home currency of US dollars. The cardholder travels to England and makes a first payment card purchase from a first English merchant offering a first item for sale in the currency of British pound sterling for a first purchase amount on a first day. The first purchase is approved or authorized by the payment system at a purchase amount applying the conversion rate of US dollars to British pound sterling at the time of sale on the first day.

The same US resident cardholder then makes a second purchase with the same payment card from a second English merchant offering a second item for sale in the currency of British pound sterling in a second amount on a second day. The second purchase is also approved or authorized by the payment system at the time of sale at the current conversion rate of US dollars to British pound sterling on the second day. Each of the first and second payment card transactions may finally clear and settle, however, on the payment system in a purchase amount according to the applicable currency conversion rate at the time of clearing and settlement sometime later on a third day.

Since the conversion rates fluctuate over time, the conversion rate at the time of settlement (the third day) may be different from the conversion rate that applied to the first and second purchases on either of the first day or the second day. If so, the clearing and settlement of the charges is made at a different conversion rate than at the time of the purchases on the first or second day. Accordingly, the cardholder is charged for the first and second purchases at an amount other than the purchase price at the respective times of sale, and the merchants receive payment in the corresponding amounts which are different from the offer price at the time of sale. Over a number of transactions that the cardholder may make while visiting England over the time of the visit, the charges posted on the cardholder account after clearing and settlement may not match the recollection of the cardholder.

While the difference in payment amounts attributable to conversion rates at the time of purchase and the time of final settlement amount is not significant in most cases, a settlement of the transaction in an unexpectedly different amount can be an unwelcome surprise to certain cardholders, a disincentive to using a payment card for other cardholders who are not comfortable with the conversion rates, and/or confusing to some cardholders who may not recognize the settled transaction when posted to their cardholder accounts.

A cardholder typically is billed monthly by the payment card issuer. When a cardholder sees a transaction charge (or charges) posted on a bill that differs from the transaction amount on the date of the transaction, confusion may result. If the cardholder does not understand that the currency conversion is made a time subsequent to the actual purchase, the cardholder may dispute the charge believing that it is incorrect or improper. Any disputed charge accordingly consumes time and resources of the issuer and acquiring banks to resolve. Such disputed charges that are caused solely by currency conversion rates negatively affect the goodwill between cardholders and issuers and negatively impact efficiencies of issuer and acquirer banks

Some cardholders may be reluctant to use their payment cards to conduct foreign exchange transactions at all. With limited exceptions, most cardholders are not familiar with the applicable currency conversion rates at the time of a payment card transaction using a foreign currency. Many cardholders may not understand exactly how the currency conversions are applied in foreign exchange transactions and by whom (e.g., individual merchants or a party to the payment system). Applicable surcharges that may apply to foreign exchange transactions may not be well understood either. In combination, most cardholders may not quickly or easily determine whether the posted charges from foreign exchange transactions are correct or incorrect. For these reasons, some cardholders opt to make purchases in foreign currency cash rather than using a payment card. That is, cardholders may forgo the convenience of a payment card while traveling to certain locales, and instead convert home currency to the foreign currency in cash before leaving their home country or after arriving in the foreign country, that may be spent while traveling.

The use of cash instead of payment cards to for traveling cardholders is not an ideal solution, however. Cardholders carrying unfamiliar cash currency in a foreign location are more vulnerable to theft, loss, and manipulation by malicious parties. Travelers short on cash may choose not to make certain purchases that otherwise would be desirable. Issuer banks and merchants may suffer from lost transactions that may have been desirably made if the cardholder was more willing to use a payment card instead of cash.

To avoid the problems discussed above, a cardholder may perhaps obtain more than one payment card from the same or different issuer banks, with each payment card designated for payment in a different currency. As such, and following the example above, a cardholder could use a first payment card designated for payment in US dollars for some transactions and a second payment card designated for payment in British pound sterling for other transactions. This presents other inconvenience to cardholders in possessing or presenting the correct payment card to make a transaction in one currency or the other. If the cards are confused, foreign currency transactions settled at another conversion rate will still result. Also, obtaining separate payment cards for each foreign currency on a multi-destination international trip is not practical for certain travelers.

The systems and methods of the disclosure facilitate foreign exchange transactions with payment cards while avoiding fluctuating currency conversion rates in settlement of payment card transactions that is problematic in the aspects discussed above. Cardholder convenience is therefore increased and cardholder disincentives to use payment cards in foreign exchange transactions are eliminated. Goodwill between cardholders and payment card issuers is preserved by processing and settling foreign exchange transactions in the actual purchase amounts. Issuer and acquirer banks may avoid having to resolve disputed charges relating to currency conversion discrepancies in the settlement of foreign exchange transactions.

In the systems and methods of the disclosure, a payment card designated for payment in a home currency may be linked with a prepaid, virtual account (or accounts) including prepaid amounts foreign currency. For example, a payment card designated for payment in a home currency of British pound sterling may be linked with a virtual prepaid account including cardholder selected amounts of foreign currency such as US dollars or Euros. A single payment card with such linked virtual prepaid foreign currency accounts can therefore be used to make purchases in the home currency and/or in a selected one of the prepaid foreign currencies, without necessarily requiring a currency conversion to complete foreign exchange payment card transaction with a payment card designated for payment in a home currency.

For example, a cardholder having a cardholder account in the home currency of US dollars, may pre-pay a selected amount of British pound sterling and a selected amount of Euros in the virtual account for respective use in England and in Germany when traveling to those countries. When making payment card transactions with English and German merchants in each respective country, the respective prepaid foreign currency can be debited instead of the payment card account in the home currency. The entire payment card transaction is made in the foreign currency using the virtual account, and no currency conversion between dollars, pound sterling, or Euros is required to complete transactions. Foreign exchange transactions may be competed entirely from the prepaid foreign currency funds with a greater degree of transparency to the cardholder.

In one embodiment, the disclosure provides an electronic payment card processing system including at least one host computing device comprising at least one processor in communication with a memory device and a multi-party payment processing system and network for processing payment card transactions. The at least one host computing device is configured to, receive transaction data for a plurality of payment card transactions, and identify, based on the received transaction data, at least one foreign exchange transaction including a payment card account designated for payment in a home currency and a merchant designated for payment in a foreign currency. For each payment card account in an identified foreign exchange transaction, the at least one host computing device is configured to: identify whether at least one virtual prepaid foreign currency account that is linked to the payment card account is available; and if the at least one available virtual prepaid foreign currency account is available, apply at least a portion of the funds from the at least one virtual prepaid foreign currency account to satisfy the payment for the foreign exchange transaction.

In the system of the disclosure, the at least one host computing device may also be configured to: compare a bank identification number (BIN) of the cardholder account to a merchant id in the transaction data to identify the at least one foreign exchange transaction; and identify, in reference to a primary account number (PAN) of the cardholder account, whether the at least one available virtual prepaid foreign currency account is available.

The at least one host computing device may further configured to: determine whether an available virtual prepaid foreign currency account has sufficient funds to satisfy the entire payment for the foreign exchange transaction; and notify the cardholder when the at least one virtual foreign currency account has insufficient funds to satisfy the entire payment for the foreign exchange transaction. The at least one host computing device may optionally be configured to: apply a partial payment from a first available virtual foreign currency account, and apply a partial payment from a second available virtual foreign currency account to satisfy the entire payment for the foreign exchange transaction; apply a partial payment in the home currency and a partial payment from an available virtual foreign currency account to satisfy the entire payment for the transaction in the foreign currency; or decline the foreign exchange transaction when the at least one virtual foreign currency account has insufficient funds to satisfy the entire payment for the transaction in the foreign currency.

The at least one host computing device may further configured to determine a location of a cardholder, and based on the location of the cardholder, make at least one virtual foreign currency account available to satisfy at least a portion of the payment for the for the foreign exchange transaction. The at least one host computing device is configured to: accept a foreign currency deposit to at least one virtual prepaid foreign currency account by a cardholder via a payment card transaction. The system of the disclosure may also include at least one of an ACH payment system or a checking payment system, and wherein the at least one host computing device is further configured to accept a foreign currency deposit to at least one virtual prepaid foreign currency account via the ACH payment system or a checking payment system. The at least one host computing device is also configured to lock or unlock the at least one virtual foreign currency account according to a cardholder provided switch parameter.

In another embodiment the disclosure provides a method for electronically responding to disputed charges for payment card transactions processed by a multi-party payment processing system. The method is implemented with at least one host computing device having at least one processor in communication with a memory device and the multi-party payment processing system. The method includes receiving transaction data for a plurality of payment card transactions, and identifying, by the at least one host computing device and based on the received transaction data, at least one foreign exchange transaction including a payment card account designated for payment in a home currency and a merchant designated for payment in a foreign currency. The method also includes, for each payment card account in an identified foreign exchange transaction, identifying by the at least one host computing device whether at least one virtual prepaid foreign currency account that is linked to the payment card account is available. If the at least one available virtual prepaid foreign currency account is available, the method includes applying at least a portion of the funds from the at least one virtual prepaid foreign currency account to satisfy the payment for the foreign exchange transaction.

The method also includes comparing, by the at least one host computing device, a bank identification number (BIN) of the cardholder account to a merchant id in the transaction data to identify the at least one foreign exchange transaction; and identifying, by the at least one host computing device and in reference to a primary account number (PAN) of the cardholder account, whether the at least one available virtual prepaid foreign currency account is available.

The method may further include determining whether an available virtual prepaid foreign currency account has sufficient funds to satisfy the entire payment for the foreign exchange transaction; and notifying the cardholder when the at least one virtual foreign currency account has insufficient funds to satisfy the entire payment for the foreign exchange transaction. The method may likewise include: applying a partial payment from a first available virtual foreign currency account, and applying a partial payment from a second available virtual foreign currency account to satisfy the entire payment for the foreign exchange transaction; applying a partial payment in the home currency and a partial payment from an available virtual foreign currency account to satisfy the entire payment for the transaction in the foreign currency; or declining the foreign exchange transaction when the at least one virtual foreign currency account has insufficient funds to satisfy the entire payment for the transaction in the foreign currency.

The method may also include determining a location of a cardholder, and based on the location of the cardholder, make at least one virtual foreign currency account available to satisfy at least a portion of the payment for the for the foreign exchange transaction. The method may likewise include accepting a foreign currency deposit to at least one virtual prepaid foreign currency account by a cardholder via a payment card transaction. The at least one host computing device is in communication with at least one of an ACH payment system or a checking payment system, and the method further includes accepting a foreign currency deposit to at least one virtual prepaid foreign currency account via the ACH payment system or a checking payment system. The method may also include locking or unlocking the at least one virtual foreign currency account according to a cardholder provided switch parameter.

The technical problems addressed by the payment card processing systems and methods of the disclosure include at least one of: (i) inefficiencies in processing foreign exchange transaction processing on a multi-party payment processing system for payment by card transactions; (ii) inability to avoid uncertainties of fluctuating currency conversion rates in settlement of foreign exchange transactions involving payment cards; (iii) inability to provide easily understood and accurate information to cardholders regarding foreign exchange transactions; (iv) problematic exposure to chargeback requests in the processing of foreign exchange transactions that are not actually problematic; (v) limiting cardholder options to complete foreign exchange transactions with payment cards; (vi) inability to provide debit capability for transactions involving multiple currencies without issuing multiple payment cards; and (vii) lack of control and security of debit card accounts for traveling cardholders.

The payment card processing systems and methods of the disclosure to the cardholder may be implemented using computer programming or engineering techniques including computer software, firmware, hardware, or any combination or subset thereof, wherein the technical effects may be achieved by (i) processing foreign exchange transactions with foreign currency funds on a multi-party payment processing system for payment by card transactions without requiring currency conversions; (ii) providing opportunities to cardholders to avoid fluctuating currency conversion rates in settlement of foreign exchange transactions involving payment cards; (iii) providing easily understood and verifiable information to cardholders regarding foreign exchange transactions; (iv) avoidance of chargeback requests in the processing of foreign exchange transactions; (v) expansion of cardholder options to complete foreign exchange transactions with payment cards; (vi) providing debit capability for transactions involving multiple currencies with a single payment card; and (vii) enhancing control and security of debit card accounts for traveling cardholders with switches and user preferences.

The resulting technical benefits achieved by the payment card processing systems and methods include at least one of: (i) processing foreign exchange transactions with pre-paid foreign currency funds on a multi-party payment processing system for payment by card transactions without requiring currency conversions; (ii) providing opportunities to cardholders to prepay foreign currency transaction funds to avoid fluctuating currency conversion rates in settlement of foreign exchange transactions involving payment cards; (iii) facilitating straightforward and verifiable information to cardholders regarding foreign exchange transactions; (iv) elimination of chargeback requests in the processing of foreign exchange transactions based on confusing settlement charges; (v) facilitating cardholder options to complete foreign exchange transactions in multiple difference currencies with one payment card; (vi) providing debit capability for transactions involving multiple currencies with a single payment card; and (vii) providing cardholder security controls including switches and user preferences.

In one embodiment, a computer program is provided, and the program is embodied on a computer-readable medium. In an example embodiment, the system may be executed on a single computer system, without requiring a connection to a server computer. In a further example embodiment, the system may be run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Apple Inc. located in Cupertino, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus, are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, any type of virtual card (e.g. virtual cards generated by issuers and/or third party processors via mobile bank or desktop apps) and/or any other device that may hold payment account information, such as mobile phones, Smartphones, personal digital assistants (PDAs), key fobs, digital wallets, smart devices (i.e., smart TV) and/or computers. Each type of transactions card can be used as a method of payment for performing a transaction. As used herein, the term “payment account” is used generally to refer to the underlying account with the transaction card. In addition, cardholder card account behavior can include but is not limited to purchases, fund transfer, personal payment, management activities (e.g., balance checking), bill payments, achievement of targets (meeting account balance goals, paying bills on time), and/or product registrations (e.g., mobile application downloads).

As used herein, the term “transaction data” refers to data that includes at least a portion of a cardholder's account information (e.g., cardholder name, account identifier, credit line, security code, and/or expiration data) and at least a portion of purchase information (e.g., price, a type of item and/or service, SKU number, item/service description, purchase date, and/or confirmation number) supplied by a merchant from which the cardholder is making a purchase.

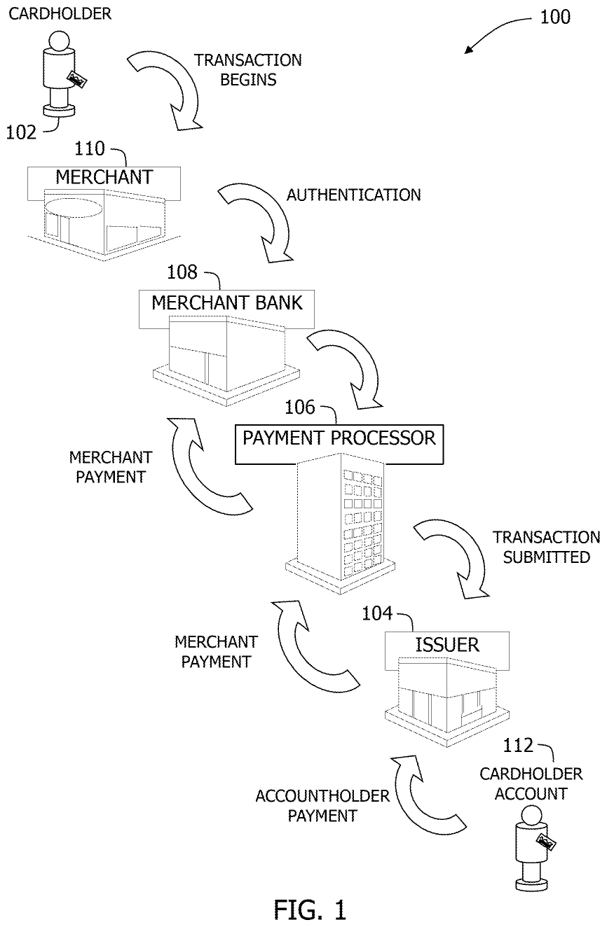

FIG. 1 is a schematic diagram illustrating an exemplary multi-party payment card processing system 100 for processing payment card transactions. The present system and method relates to payment card processing system 100, such as a credit card payment network using a payment processor network 106 such as the Mastercard® payment network 106 according to a proprietary communications standard promulgated by Mastercard International Incorporated for the exchange of financial transaction data between financial institutions that are registered with Mastercard International Incorporated. (Mastercard is a registered trademark of Mastercard International Incorporated located in Purchase, N.Y.).

In payment card processing system 100, a financial institution, such as an issuing bank 104, issues a payment card, such as a credit card account or a debit card account, to a cardholder 102, who uses the payment card to tender payment for a purchase from a merchant 110. To accept payment with the payment card, merchant 110 must normally establish an account with a financial institution that is part of the financial payment system. This financial institution is usually called the “merchant bank” or the “acquiring bank” or simply “acquirer”. When a cardholder 102 tenders payment for a purchase with a payment card (also known as a financial transaction card), merchant 110 passes authorization request through merchant bank 108 and the payment network 106 to issuer 104 for the amount of the purchase. The request may be performed over the telephone or via a website, but is oftentimes performed through the use of a point-of-sale terminal, which reads the cardholder's account information from the magnetic stripe or the chip on the payment card and communicates electronically with the transaction processing computers of merchant bank 108. Alternatively, merchant bank 108 may authorize a third party to perform transaction processing on its behalf. In this case, the point-of-sale terminal will be configured to communicate with the third party. Such a third party is usually called a “merchant processor” or an “acquiring processor.”

Using payment network 106, the computers of merchant bank 108 or the merchant processor will communicate with the computers of issuing bank 104 to determine whether the cardholder's account is in good standing and whether the purchase is covered by the cardholder's available credit line or account balance. Based on these determinations, the request for authorization will be declined or accepted. If the request is accepted, the transaction is given a bank network reference number, such as the Banknet Reference Number used by Mastercard International Incorporated, an authorization code, and/or other transaction identifiers that may be used to identify the transaction.

The payment network may be configured to process authorization messages, such as ISO 8583 compliant messages and ISO® 20022 compliant messages. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

During the authorization process of the payment card processing system, the clearing process is also taking place. During the clearing process, merchant bank 108 provides issuing bank 104 with information relating to the sale. No money is exchanged during clearing. Clearing (also referred to as “first presentment”) involves the exchange of data required to identify the cardholder's account 112 such as the account number, expiration date, billing address, amount of the sale, and/or other transaction identifiers that may be used to identify the transaction. Along with this data, banks in the United States also include a bank network reference number, such as the Banknet Reference Number used by Mastercard International Incorporated, which identifies that specific transaction. When the issuing bank 104 receives this data, it posts the amount of sale as a draw against the available credit in the cardholder account 112 and prepares to send payment to the merchant bank 108.

When a request for authorization is accepted, the available credit line or available account balance of cardholder's account 112 is decreased. Normally, a charge is not posted immediately to a cardholder's account 112 because bankcard associations, such as Mastercard International Incorporated, have promulgated rules that do not allow a merchant to charge, or “capture,” a transaction until goods are shipped or services are delivered. When a merchant 110 ships or delivers the goods or services, merchant 110 captures the transaction by, for example, appropriate data entry procedures on the point-of-sale terminal. If a cardholder 102 cancels a transaction before it is captured, a “void” is generated. If a cardholder 102 returns goods after the transaction has been captured, a “credit” is generated.

After a transaction is captured, the transaction is settled between merchant 110, merchant bank 108, and issuing bank 104. Settlement refers to the transfer of financial data or funds between the merchant's account, merchant bank 108, and issuing bank 104 related to the transaction. Usually, transactions are captured and accumulated into a “batch,” which is settled as a group.

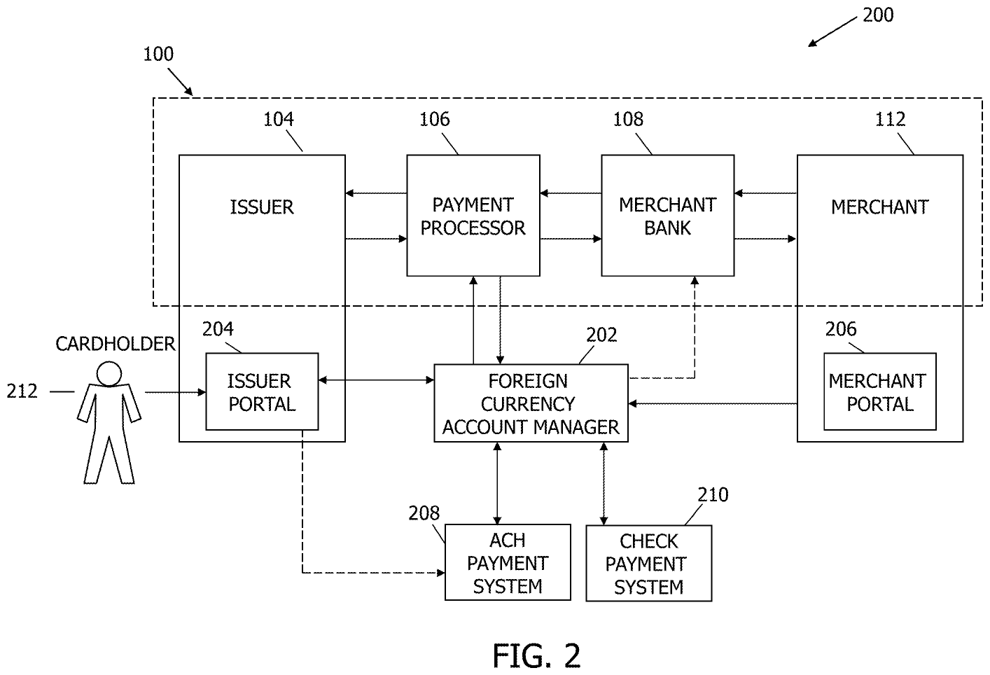

FIG. 2 is a schematic diagram illustrating an exemplary multi-party network system 200 that includes a host foreign currency account manager computing device 202 and the payment network and system 100 described above including issuer 104, payment processor 106, merchant bank 108, and merchant 110, The foreign currency account manager computing device 202 is in communication with the payment processor 106, an issuer portal 204, an optional merchant portal 206, an ACH (automated clearing house) payment system or device 208 for accepting deposit payments from a user's checking or savings account, as well as a check payment system or device 210 to fund prepaid, virtual foreign currency payment accounts linked to cardholder accounts as described below.

Cardholder 212, using a cardholder computing device, accesses issuer portal 204 to enroll as an authorized user for the services of the foreign currency account manager computing device 202. Once enrolled, the cardholder 212 may access information regarding the cardholder account and any prepaid, virtual foreign currency payment accounts that may be linked to the cardholder account. The cardholder may make deposits to a virtual foreign currency payment account or accounts, input user preferences regarding use and availability of the virtual foreign currency payment accounts, and check statements via the issuer portal 204 and the foreign currency account manager computing device 202. Funds may be deposited in the virtual foreign currency accounts by cardholders in various different ways.

For example, the cardholder 212 may deposit funds to a selected virtual foreign currency account as a payment card transaction run through the payment system 100 at the applicable conversation rate. As such, a US resident cardholder having a payment card home currency of US dollars may purchase a desired amount of foreign currency (e.g., British pound sterling) via a payment card transaction subject to the conversion rate at the time of deposit. The converted amount is debited from the home currency account and credited to the virtual foreign currency account.

As another example, the cardholder 212 may deposit funds to a selected virtual foreign currency account by electronic fund transfer from a checking or savings account via the ACH system 208. The applicable conversions for transferred funds are converted to the foreign currency at the time of deposit, with the amount debited from the checking or savings account and credited to the virtual foreign currency account. Likewise, the cardholder 212 may deposit funds a selected virtual foreign currency account via the check payment system 210 with the applicable conversion for check payments being converted to the foreign currency at the time of deposit, with the deposit amount debited on the check payment system and credited to the virtual foreign currency account. In instances wherein the ACH system 208 or check payment system 210 are provided by the issuer 104, this could all be done via the issuer portal 204. The ACH system 208 or check payment system 210 could alternatively represent a bank other than the issuer, in which case the cardholder 212 would use a separate portal to interface with them to deposit funds.

Funds may be deposited at any time convenient to the cardholder 312 to establish or replenish prepaid foreign currency funds for use in foreign exchange transactions without incurring a subsequent currency conversion in the settlement of the foreign exchange transactions. Multiple virtual foreign currency accounts can be established having respectively different currencies to facilitate different types of foreign exchange transactions in different foreign countries without incurring a subsequent currency conversion in the settlement of the foreign exchange transactions. Likewise, funds in a selected virtual foreign currency account (or accounts) could be reconverted back to the home currency at any time desired.

The cardholder may load or unload the prepaid, virtual foreign currency accounts with the desired foreign currencies at any time. The loading of the prepaid, virtual foreign currency account may result in a one-time, currency conversion at the time of deposit into the prepaid, virtual foreign currency account. For example, a conversion may be made from US dollars to the desired foreign currency (e.g., British pound sterling) or currencies (e.g., British pound sterling and Euros) when funding the prepaid, virtual foreign currency account(s).

In contemplated embodiments, the prepaid foreign currency deposits may be made accepted by the foreign exchange account manager device 202, and the cardholder may receive a same day conversion rate that is immediately applied. After that, the cardholder may use the prepaid foreign currency funds to make corresponding foreign exchange transactions without a subsequent conversion, up to the amount of the prepaid foreign currency funds deposited. Charges posted to the prepaid account accordingly match the purchase amounts of foreign exchanges made and are therefore transparent to the cardholder.

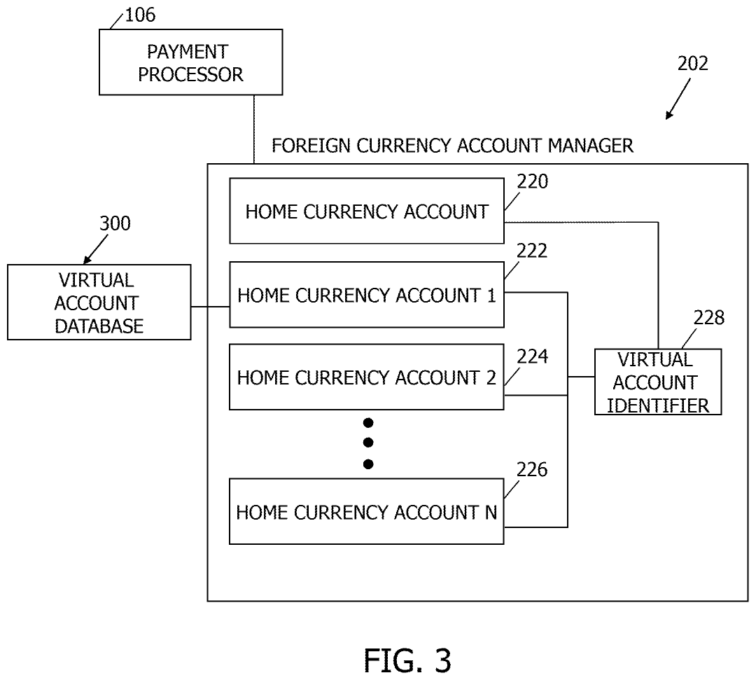

FIG. 3 illustrates an operational schematic diagram for the foreign currency account manager 202. The foreign currency account manager system 202 links a home currency payment card account 220 with any number n of virtual foreign currency accounts 222, 224, 226. The accounts 220, 222, 224, 226 and 228 may be linked by an account identifier 228. In a contemplated embodiment, the account identifier 228 is the primary account number (PAN) of the cardholder's payment card account, although other identifiers may likewise be utilized. The virtual foreign currency accounts may be created by each cardholder and linked to the PANs of each cardholder.

The PANs and linked virtual foreign currency accounts may be stored in a virtual account database 300 for retrieval by the foreign currency account manager system 202 when processing transactions. Cardholder preferences may be also be stored in the virtual account database 300 and applied as default rules for foreign exchange transaction contingencies. The foreign exchange account manager device 202 is in communication with the multi-party payment processing system and as payment card transactions are made the foreign exchange account manager device recognizes foreign exchange transactions as the occur and applies prepaid foreign currency funds from one or more of the linked virtual foreign currency accounts 222, 224, 226 to complete foreign exchange transactions. Payment cards and prepaid, virtual foreign currency accounts may be linked in any manner desired such that the foreign exchange account manager device can recognize the prepaid, virtual foreign currency accounts associated with payment cards.

As payment card transactions are processed, the foreign currency account manager 202 receives payment card transaction data from the payment processor 106. For example, by comparing the BIN number of the payment card to the merchant id in the transaction data, the foreign currency account manager 202 can identify and distinguish foreign exchange transactions from non-foreign exchange transactions that may be completed solely in the home currency. Once a foreign exchange transaction is identified, the foreign currency account manager 202 can retrieve the linked virtual counts via the identifier (e.g., the PAN of the payment card from the transaction data) and retrieve any linked virtual foreign currency account information from the virtual account database 300 for any of the enrolled cardholders.

In one embodiment, for each enrolling cardholder, the prepaid virtual foreign currency accounts may be linked to the respective primary account number (PAN) number of each respective enrolling cardholder, such that prepaid, virtual foreign currency account information can located in the database 300 in reference to identified PAN numbers of enrolled cardholders for the services of the foreign exchange account manager device. With respect to any enrolled cardholder, any foreign exchange transactions conducted with a payment card linked to a prepaid virtual foreign currency account is therefore detected by the foreign exchange account manager device 202 according to the PAN numbers of payment cards in each payment card transaction processed on the payment network.

For example, when a foreign exchange transaction is detected between an enrolled cardholder having account 220 and a merchant having a merchant id indicating payment currency in a foreign currency (e.g., British pound sterling), the foreign currency account manager 202 looks to see if a virtual foreign currency account 222 is linked to the PAN number that includes prepaid funds in the British pound sterling currency. If sufficient funds exist in the virtual account 222 to cover the transaction amount, the foreign currency account manager 202 approves the transaction and the virtual account 222 is debited for the purchase amount in the transaction using only the foreign currency.

If sufficient funds do not exist in the virtual account 222 to cover the transaction amount, the foreign currency account manager 202 looks to see if a second virtual foreign currency account 224 is linked to the PAN number of the account 220 that includes additional prepaid funds in another foreign currency. If so, the foreign currency account manager 202 can approve the transaction and apply a combination of the prepaid funds in the two virtual accounts 222 and 224, debiting each of the two virtual accounts 222 and 224 accordingly. Three or more virtual accounts 222, 224 and 226 may likewise be combined to complete a transaction as desired by the cardholder.

Alternatively, any deficiency in a virtual account 222 (or accounts) 222, 224, 226 may be run as a payment card transaction on the account 220 in the home currency, subject to the available credit limit and account balance as in any other payment card transaction. The cardholder may optionally be notified by the foreign currency account manager 202 in any of these scenarios, either for specific approval to proceed with the transaction in one of the aforementioned ways, as a reminder of default rules and preferences selected by the cardholder, or as a notification of a declined transaction when funds do not exist to complete the transaction or when the default rules and cardholder preferences prohibit the transaction.

The foreign currency account manager 202 may also lock or unlock the virtual foreign currency accounts 222, 224, 226 for any particular cardholder in either an automated or manual manner depending on cardholder preference. When the cardholder uses a device having location services and when the cardholder grants permission for the foreign currency account manager 202 to use them, the foreign currency account manager 202 may make funds in the virtual accounts available or unavailable depending on the cardholder's actual location. As such, and for example, when an enrolled cardholder arrives in England, virtual account funds in British pound sterling from the account 220 can be unlocked, and when the cardholder leaves England, the virtual account funds in British pound sterling in the account 222 can be locked.

As another option, an enrolled cardholder can enter travel dates for an unlocking of virtual account funds in the accounts 222, 224, 226 by the foreign currency account manager 202. As such, and for example, the cardholder may input to the foreign currency account manager 202 that she will be in England from December 1 through December 7, and the foreign currency account manager 202 will accordingly unlock the virtual account funds in British pound sterling of the account 222 for use in transactions taking place December 1 through 7, with the foreign currency account manager 202 automatically locking the virtual account funds in British pound sterling in the account 222 on December 8. Alternatively, a simple on and off button or corresponding selection may be manually input by an enrolled cardholder to the foreign currency account manager 202 to switch one or more of the virtual account funds in accounts 222, 224, 226 on or off on demand for use and non-use in making transactions.

The foreign currency account manager 202 and the linked virtual prepaid foreign currency accounts 222, 224, 226 facilitates flexible use of payment cards to conduct transactions in multiple currencies with a single payment card using prepaid funds that do not necessarily require currency conversions and discrepancies between purchase amounts and posted charges that appear on card account statements. Convenience to cardholders is greatly enhanced, and disincentives to use payment cards in foreign exchange transactions are mitigated, if not eliminated.

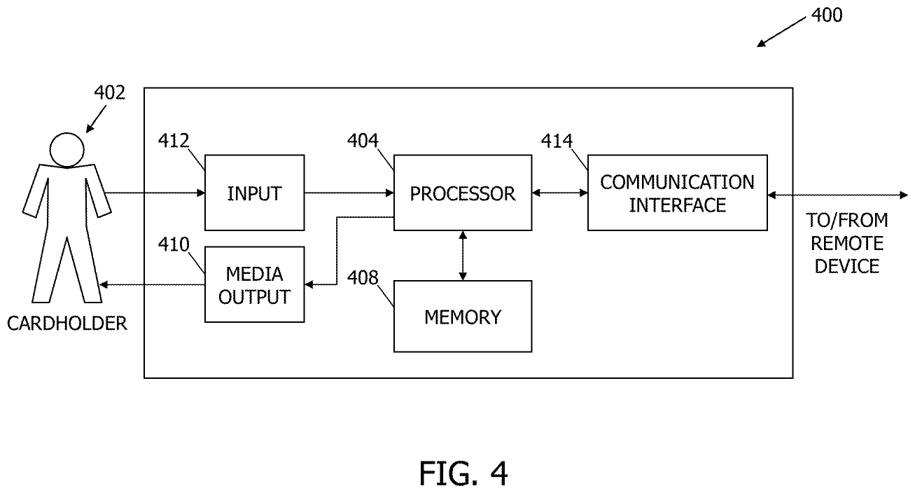

FIG. 4 illustrates an example configuration of a device 400 operated by a user 402, such as any of the parties described above in the payment network or a cardholder. User device 400 may include, but is not limited to, a smart phone, a tablet, a notebook or laptop computer, a desktop computer, and a website. In the example embodiment, device 400 includes a processor 404 for executing instructions. In some embodiments, executable instructions are stored in a memory area 408. Processor 404 may include one or more processing units, for example, a multi-core configuration. Memory area 408 is any device allowing information such as executable instructions and/or written works to be stored and retrieved. Memory area 408 may include one or more computer readable media.

The device 400 may also include at least one media output component 410 for presenting information to user 402. Media output component 410 is any component capable of conveying information to user 402. In some embodiments, media output component 410 includes an output adapter such as a video adapter and/or an audio adapter. An output adapter is operatively coupled to processor 404 and operatively couplable to an output device such as a display device, a liquid crystal display (LCD), organic light emitting diode (OLED) display, or “electronic ink” display, or an audio output device, a speaker or headphones.

In some embodiments, the device 400 includes an input device 412 for receiving input from user 402. Input device 412 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 410 and input device 412. The device 400 may also include a communication interface 414, which is communicatively couplable to a remote device in the card payment system network or with other remote devices via networks other than the payment system. Communication interface 414 may include, for example, a wired or wireless network adapter or a wireless data transceiver for use with a mobile phone network, Global System for Mobile communications (GSM), 3G, or other mobile data network or Worldwide Interoperability for Microwave Access (WIMAX), or an 802.11 wireless network (WLAN).

Stored in memory area 408 are, for example, computer readable instructions for providing a user interface to user 402 via media output component 410 and, optionally, receiving and processing input from input device 412. A user interface may include, among other possibilities, a web browser and client application. Web browsers enable users, such as user 402, to display and interact with media and other information typically embedded on a web page or a website. An application allows user 402 to interact with a server application from a server system.

Multiple user devices 400 are contemplated and respectively provided for use by cardholders, representatives of the issuer, representatives of the payment processor, representatives of the merchant bank, representatives of the merchant, and possibly others to effect the system as shown in FIG. 3. Additional and/or alternative users and user devices may be provided, however, as desired for use with the system.

In a variety of contemplated examples, different combinations of user devices, being the same or different from one another, may be utilized in the system with otherwise similar effect. One or more of the user devices may be a mobile device, such as any mobile device capable of interconnecting to the Internet including a smart phone, personal digital assistant (PDA), a tablet, or other web-based connectable equipment. Alternatively, one or more of the user devices may be a desktop computer or a laptop computer. Each of the user devices may be associated with a different user as described. Each user device may be interconnected to the Internet through a variety of interfaces including a network, such as a local area network (LAN) or a wide area network (WAN), dial-in connections, cable modems and special high-speed ISDN lines.

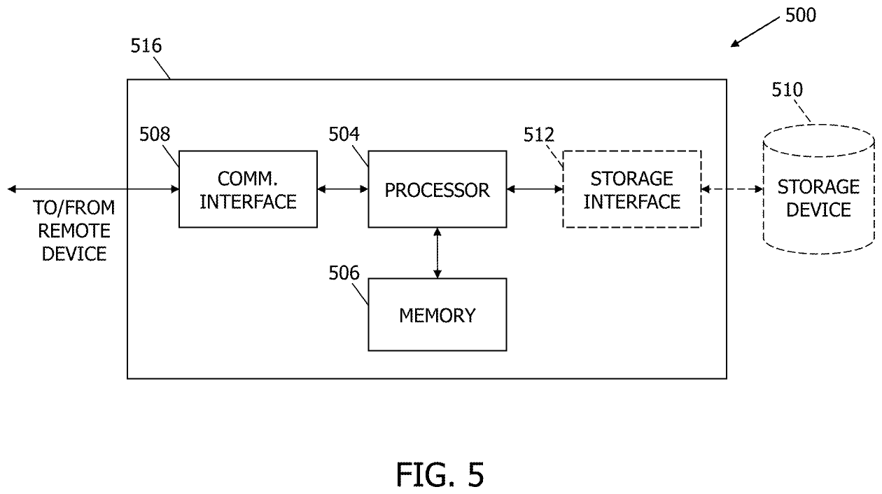

FIG. 5 illustrates an example configuration 500 of a foreign currency account manager computing device 516 as shown in FIG. 3 that confers the foreign currency account management services. The computing device 516 is sometimes referred to herein as a server-based network “host” device that manages foreign exchange transaction identification, associated foreign exchange transaction data, virtual foreign currency account identification and administrations such as accepting deposits, making debits and providing accounting and reports for review by cardholders. It is not strictly necessary, however, that in all embodiments that the host computing device is a server system.

As shown in FIG. 5, the host foreign currency account manager computing device 516 includes a processor 504 for executing instructions. Instructions may be stored in a memory area 506, for example. Processor 504 may include one or more processing units (e.g., in a multi-core configuration).

Processor 504 is operatively coupled to a communication interface 508 such that host foreign currency account manager computing device 516 is capable of communicating with a remote device such as a merchant portal, an issuing portal, a payment processor, an ACH payment device or a check payment system device. For example, communication interface 508 may receive or transmit transaction data, foreign exchange identification data, virtual foreign currency account data, account statements and reports to the issuer portal merchant portal and/or another client device via a network. In some cases the communication interface 508 may also directly communicate with a user device of customer and provide notifications or accept deposits or cardholder preferences via dedicated portals.

Processor 504 may also be operatively coupled to a storage device 510. Storage device 510 is any computer-operated hardware suitable for storing and/or retrieving data. In some embodiments, storage device 510 is integrated in host foreign currency account manager computing device 516. For example, host foreign currency account manager computing device 516 may include one or more hard disk drives as storage device 510. In other embodiments, storage device 510 is external to host foreign currency account manager computing device 516 and may be accessed by a plurality of server computer devices. For example, storage device 510 may include multiple storage units such as hard disks or solid state disks in a redundant array of inexpensive disks (RAID) configuration. Storage device 510 may include a storage area network (SAN) and/or a network attached storage (NAS) system.

The storage device 510 may include a database server and database which contains information and transaction data for enrolled cardholders. In one embodiment, the database is centralized and stored on the server system 500. In an alternative embodiment, the database is stored remotely from the server system 500 and may be non-centralized. The database may store transaction data including data relating to merchants, merchant locations, cardholders, foreign exchange transaction data and data needed for the prepaid foreign exchange transaction services described. The database may include foreign exchange data that is linked to transaction data for ease of access, retrieval and review to assess the benefits and performance of the system from either a cardholder or issuer perspective. The database may include a plurality of files of information for enrolled cardholders, as well as recorded data regarding deposits and debits for the virtual accounts for record keeping purposes.

In some embodiments, processor 504 is operatively coupled to storage device 510 via a storage interface 512. Storage interface 512 is any component capable of providing processor 504 with access to storage device 510. Storage interface 512 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 504 with access to storage device 510.

Memory area 506 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

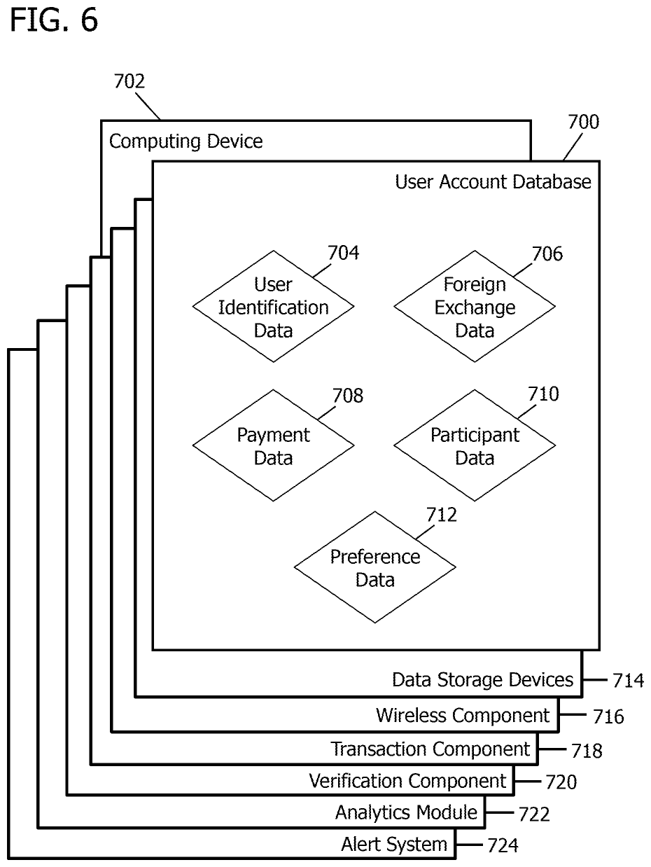

FIG. 6 shows an example configuration of a user account database 700, within a computing device 702, along with other related computing components, that may be used to create, organize, and monitor a plurality of user data associated with a user account. In some embodiments, computing device 702 is the same or similar to server system 500. User account database 700 is coupled to several separate components within computing device 702, which perform specific tasks.

In the example embodiment, database 700 includes user identification data 704, foreign exchange data 706, payment data 708, participant data 710, and preference data 712. In contemplated embodiments, user identification data 704 includes, but is not limited to, a user name, a user address, and a user phone number. Foreign exchange data 706 includes data associated with foreign exchange transaction identification, communication, and application of prepaid foreign funds in virtual accounts to facilitate foreign exchange transactions as described herein. Payment data 708 includes, but is not limited to, card information, payment history, and a billing address. Participant data 710 includes information associated with participating merchants, including merchant identifiers, address information, contact information, etc. Preference data 712 includes data associated with cardholder preferences, contact preferences for notifications generated by computing device 702, cardholder on/off and switching inputs, geolocation service preferences, etc.

Computing device 702 includes the database 700, as well as data storage devices 714. Computing device 702 also includes a wireless component 716 and a transaction component 718 for correlating, for example, payment card transactions. An analytics module 722 is included for analyzing transactions, enrollment status, the foreign exchange transaction data and other items of interest. Further included is a verification module 720 that may communicate with a device in the payment network or another device to make deposits to the virtual accounts, and an alert module 724 for transmitting an alert to a cardholder, merchant or an issuer, or to any other interested party so that possible fraudulent activity may be timely investigated and resolved.

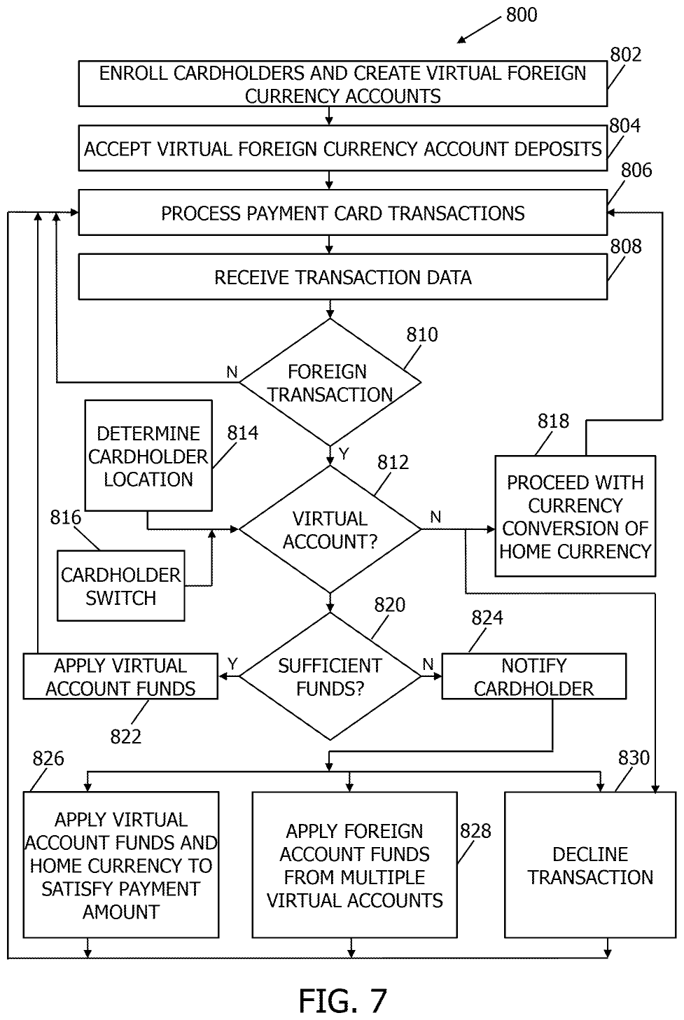

FIG. 7 shows an exemplary process 800 of managing prepaid foreign currency accounts in the systems shown and describe in relation to FIGS. 1-6. In the example shown, the process 800 is implemented by the foreign currency account manager computing device in communication with the multi-party payment processing system and network for processing payment card transactions, and effectively implements the virtual, prepaid foreign currency account management to beneficially facilitate foreign exchange transactions.

At step 802, cardholders are enrolled for the foreign currency account manager services. Enrollment includes acceptance and acknowledgement of applicable terms and conditions for the foreign currency account manager services, login and password creation, identification of the payment card of the cardholders to which the foreign currency account manager services apply. Enrollment may be performed with respect to existing payment card accounts for existing cardholders or with respect to new payment card accounts for new cardholders. Enrollment may be made through the issuer portal or in another portal to obtain access to the services of the foreign currency account manager computing device.

In contemplated embodiments, the enrollment includes opt-in informed consent of users to data usage by the system consistent with consumer protection laws and privacy regulations. In some embodiments, the enrollment data and/or other collected data may be anonymized and/or aggregated prior to receipt such that no personally identifiable information (PII) is received in the operation of the foreign currency account management services. In other embodiments, the system may be configured to receive enrollment data and/or other collected data that is not yet anonymized and/or aggregated, and thus may be configured to anonymize and aggregate the data. In such embodiments, any PII received by the system is received and processed in an encrypted format, or is received with the consent of the individual with which the PII is associated. In situations in which the systems discussed herein collect personal information about individuals including cardholders or merchants, or may make use of such personal information, the individuals may be provided with an opportunity to control whether such information is collected or to control whether and/or how such information is used. In addition, certain data may be processed in one or more ways before it is stored or used, so that personally identifiable information is removed.

At step 804, the virtual foreign currency accounts are accepted for each enrolled cardholder including the virtual account identifier described above that links each virtual account to the main cardholder account in the home currency (e.g., the PAN of the payment card account), and deposit of funds are accepted as described above or in any another manner as desired. Deposits may be made to the virtual accounts through the issuer portal or by another portal to load prepaid foreign currency funds in the virtual account for the purposes of the foreign currency account manager computing device. Once deposits are made they may be applied by the foreign currency account manager computing device, which also provides for appropriate accounting of the virtual accounts as debits are made.

The acceptance at step 804 may also include establishment of the virtual accounts and acceptance of cardholder preferences for foreign currency account manager services, notifications, and contingency preferences for transactions in which insufficient funds are available in a given virtual foreign currency account. While steps 802 and 804 are shown separately, they may be effectively combined into a single step in another embodiment. Once the deposits are made in the virtual accounts, prepaid funds are available for foreign exchange transactions.

At step 806, payment card transactions are processed by the payment system as described above, and transaction data is received at step 808 by the foreign currency account manager computing device. The transaction data may be received from the payment processor of the payment network or another device in the payment network. As such, the foreign currency account manager computing device receives transaction data for a plurality of payment card transactions between cardholders and merchants.

At step 810, the foreign currency account manager computing device identifies a foreign exchange transaction from the transaction data received. For example, the BIN of the payment card and the merchant id may be compared to determine whether the payment transaction involves a foreign currency. If a transaction is not identified as a foreign exchange transaction at step 810, the transaction may be approved as normal on the payment network and payment may be made in the home currency of the payment card.

If a transaction is identified as a foreign exchange transaction at step 810, the foreign currency account manager computing device proceeds to identify whether a virtual account linked to the payment card account is available at step 812. Optionally, the identification of the virtual account may include determining the cardholder location at step 814, which in turn locks or unlocks a virtual account according to user preference or as a system default in use as described above. Also optionally, the status of a cardholder switch as shown at step 816 may also determine whether funds in a virtual account are locked or unlocked and available for use. Locked funds are not available for purposes of step 812.

If no virtual account is available at step 812, at step 818, the transaction may proceed in a conventional manner at step 818 via a conversion of the home currency and the main payment card account. Alternatively, the transaction may be declined as shown at step 830.

If a virtual account is available at step 812, the foreign currency account manager computing device proceeds at step 820 to determine whether sufficient funds are available to satisfy the entire purchase amount for the foreign exchange transaction. When sufficient funds exist, the foreign currency account manager computing device proceeds to approve the transaction and apply the virtual account funds as payment for the transaction as shown at step 822. The foreign currency account manager computing device debits the virtual account in the amount of the payment made. No currency conversion is required in this case since the transaction is completed entirely with the prepaid foreign currency funds.

If sufficient funds are not available in a virtual account at step 820, at step 824 the foreign currency account manager computing device proceeds to notify the cardholder that sufficient prepaid foreign currency funds do not exist in the virtual account to satisfy the payment amount in the transaction. The notification may be informational only or may include cardholder options to respond.

For example, in response to the notification of step 824, the cardholder may opt to apply the available foreign currency funds in the virtual account and charge the deficiency to the main payment account in the home currency as shown at step 826. The transaction may be approved and the virtual account and the main account are each debited in the corresponding amounts.

The cardholder may also opt to apply available foreign currency funds of more than one virtual account to make the payment required for the transaction as shown at step 828, assuming that the combined accounts have sufficient assets to cover the entire amount of the transaction. The transaction may be approved and each virtual account may be debited in the corresponding amounts.

The cardholder may alternatively opt to decline the transaction as shown at step 830.

Steps 826 and 828 will each require a currency conversion to complete such that the notification at step 824 is appropriately provided, although in other embodiments the notification may be considered optional and need not be presented. One of the responses shown at steps 826, 828 or 830 may be automatically undertaken by default according to cardholder preferences accepted in the steps 802 or 804.

When steps 826, 828 or 830 are completed, the system returns to process payment card transactions at step 806.

When implemented in the form of a digital wallet on a cardholder device, cardholders may conveniently check balances of virtual accounts, make deposits, change user preferences and switch the virtual accounts on and off as needed. Notifications may be received on the cardholder device at much convenience and for prompt response to take any necessary actions needed. Cardholders may make deposits and adjust preferences of the foreign currency management services as pre-planned in advance of travel, while traveling, or otherwise on the go.

As will be appreciated based on the foregoing specification, the above-described embodiments of the disclosure may be implemented using computer programming or engineering techniques including computer software, firmware, hardware or any combination or subset thereof, wherein the technical effects described above are achieved. Any such resulting program, having computer-readable code, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electronic payment card processing system comprising:
at least one host computing device comprising at least one processor in communication with a memory device and a multi-party payment processing system and network for processing payment card transactions;
wherein the at least one host computing device is configured to:
receive transaction data for a plurality of payment card transactions;
identify, based on the received transaction data, at least one foreign exchange transaction including a payment card account designated for payment in a home currency and a merchant designated for payment in a foreign currency;
for each payment card account in an identified foreign exchange transaction, identify whether at least one virtual prepaid foreign currency account that is linked to the payment card account is available; and
if the at least one available virtual prepaid foreign currency account is available, apply at least a portion of the funds from the at least one virtual prepaid foreign currency account to satisfy the payment for the foreign exchange transaction.

2. The system of claim 1, wherein the at least one host computing device is configured to:
compare a bank identification number (BIN) of the cardholder account to a merchant id in the transaction data to identify the at least one foreign exchange transaction.

3. The system of claim 1, wherein the at least one host computing device is configured to:
identify, in reference to a primary account number (PAN) of the cardholder account, whether the at least one available virtual prepaid foreign currency account is available.

4. The system of claim 1, wherein the at least one host computing device is further configured to:
determine whether an available virtual prepaid foreign currency account has sufficient funds to satisfy the entire payment for the foreign exchange transaction; and
notify the cardholder when the at least one virtual foreign currency account has insufficient funds to satisfy the entire payment for the foreign exchange transaction.

5. The system of claim 1, wherein the at least one host computing device is further configured to:
apply a partial payment from a first available virtual foreign currency account, and apply a partial payment from a second available virtual foreign currency account to satisfy the entire payment for the foreign exchange transaction.

6. The system of claim 1, wherein the at least one host computing device is further configured to:
apply a partial payment in the home currency and a partial payment from an available virtual foreign currency account to satisfy the entire payment for the transaction in the foreign currency.

7. The system of claim 1, wherein the at least one host computing device is further configured to:
determine a location of a cardholder, and based on the location of the cardholder, make at least one virtual foreign currency account available to satisfy at least a portion of the payment for the for the foreign exchange transaction.

8. The system of claim 1, wherein the at least one host computing device is further configured to:
determine whether an available virtual foreign currency account has sufficient funds to satisfy the entire payment for the foreign exchange transaction; and
decline the foreign exchange transaction when the at least one virtual foreign currency account has insufficient funds to satisfy the entire payment for the transaction in the foreign currency.

9. The system of claim 1, wherein the at least one host computing device is further configured to:
accept a foreign currency deposit to at least one virtual prepaid foreign currency account by a cardholder via a payment card transaction.

10. The system of claim 1, further comprising at least one of an ACH payment system or a checking payment system, and wherein the at least one host computing device is further configured to accept a foreign currency deposit to at least one virtual prepaid foreign currency account via the ACH payment system or a checking payment system.

11. The system of claim 1, wherein the at least one host computing device is further configured to:
lock or unlock the at least one virtual foreign currency account according to a cardholder provided switch parameter.

12. A method for electronically responding to disputed charges for payment card transactions processed by a multi-party payment processing system, the method implemented with at least one host computing device having at least one processor in communication with a memory device and the multi-party payment processing system, the method comprising:
receiving transaction data for a plurality of payment card transactions;
identifying, by the at least one host computing device and based on the received transaction data, at least one foreign exchange transaction including a payment card account designated for payment in a home currency and a merchant designated for payment in a foreign currency;
for each payment card account in an identified foreign exchange transaction, identifying by the at least one host computing device whether at least one virtual prepaid foreign currency account that is linked to the payment card account is available; and
if the at least one available virtual prepaid foreign currency account is available, applying at least a portion of the funds from the at least one virtual prepaid foreign currency account to satisfy the payment for the foreign exchange transaction.

13. The method of claim 12, further comprising:
comparing, by the at least one host computing device, a bank identification number (BIN) of the cardholder account to a merchant id in the transaction data to identify the at least one foreign exchange transaction.

14. The method of claim 12, further comprising:
identifying, by the at least one host computing device and in reference to a primary account number (PAN) of the cardholder account, whether the at least one available virtual prepaid foreign currency account is available.

15. The method of claim 12, further comprising:
determining whether an available virtual prepaid foreign currency account has sufficient funds to satisfy the entire payment for the foreign exchange transaction; and
notifying the cardholder when the at least one virtual foreign currency account has insufficient funds to satisfy the entire payment for the foreign exchange transaction.

16. The method of claim 12, further comprising:
applying a partial payment from a first available virtual foreign currency account, and applying a partial payment from a second available virtual foreign currency account to satisfy the entire payment for the foreign exchange transaction.

17. The method of claim 12, further comprising:
applying a partial payment in the home currency and a partial payment from an available virtual foreign currency account to satisfy the entire payment for the transaction in the foreign currency.

18. The method of claim 12, further comprising:
determining a location of a cardholder, and based on the location of the cardholder, make at least one virtual foreign currency account available to satisfy at least a portion of the payment for the for the foreign exchange transaction.

19. The method of claim 18, further comprising:
determining whether an available virtual foreign currency account has sufficient funds to satisfy the entire payment for the foreign exchange transaction; and
declining the foreign exchange transaction when the at least one virtual foreign currency account has insufficient funds to satisfy the entire payment for the transaction in the foreign currency.

20. The method of claim 12, further comprising:
accepting a foreign currency deposit to at least one virtual prepaid foreign currency account by a cardholder via a payment card transaction.

21. The method of claim 12, wherein the at least one host computing device is in communication with at least one of an ACH payment system or a checking payment system, and the method further comprising:
accepting a foreign currency deposit to at least one virtual prepaid foreign currency account via the ACH payment system or a checking payment system.

22. The method of claim 12, further comprising:
locking or unlocking the at least one virtual foreign currency account according to a cardholder provided switch parameter.
